(19) United States
(12) Patent Application Publication
(10) Pub. No.: US 2026/0104960 A1
(43) Pub. Date: Apr. 16, 2026

(54) CONDITIONAL BLOCK FOLDING DELAY DURING BOOT-UP

(71) Applicant: Micron Technology, Inc., Boise, ID (US)

(72) Inventors: Jen Hung Liao, Zhubei City (TW); Yew Shen Teo, Singapore (SG); Jiejuan Liu, Singapore (SG); Chia Yu Kuo, Hukou Town (TW)

(21) Appl. No.: 18/911,867

(22) Filed: Oct. 10, 2024

(51) Int. Cl. G06F 11/10

(52) U.S. Cl. CPC G06F 11/1004; G06F 11/1016; G06F 11/1068

(57) ABSTRACT

At power-up of a memory sub-system, a processing device determines a bin classification of each block in a memory device of the memory sub-system based on one or more block family error avoidance (BFEA) scans. The processing device determines a predetermined portion of the blocks are classified as being in the highest bin. Based on determining the predetermined portion of the blocks of the memory device are classified as being in the highest bin, the processing device delays block folding until a host read size satisfies a read size threshold condition. Based on determining the host read size satisfies the threshold condition, the processing device performs block folding at the memory device.

### TECHNICAL FIELD

Embodiments of the disclosure relate generally to memory sub-systems and, more specifically, to techniques for performing a conditional delay of block folding in a memory device at memory sub-system boot-up.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some examples.

FIG. 2 is data flow diagrams illustrating interactions between components in the memory sub-system in performing a conditional delay of block folding in a memory device at boot-up, in accordance with some examples.

FIG. 3 is a flow diagram illustrating an example method for performing a conditional delay of block folding in a memory device at memory sub-system boot-up, in accordance with some examples.

FIG. 4 is a block diagram of an example computer system in which embodiments of the present disclosure may operate.

### DETAILED DESCRIPTION

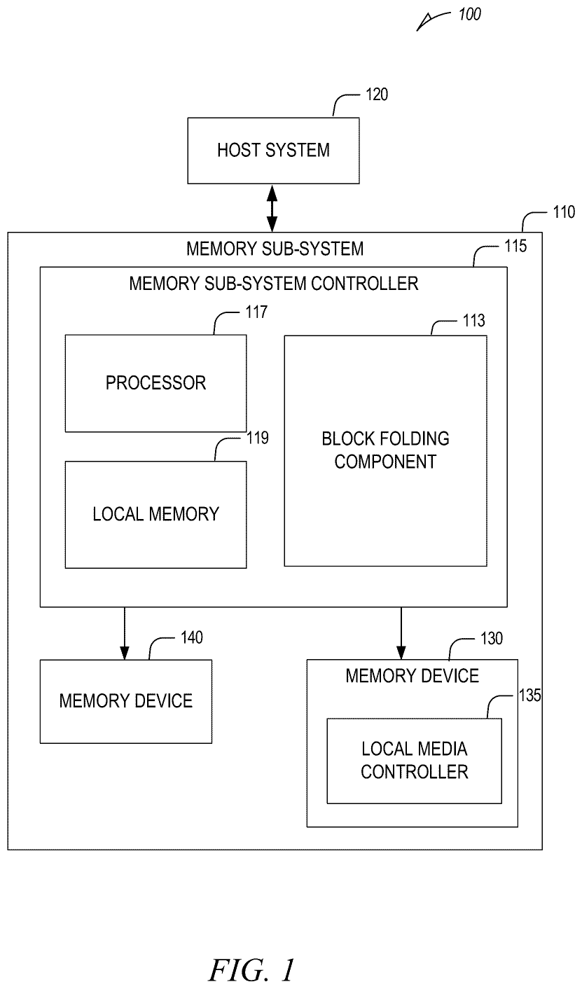

Aspects of the present disclosure are directed to an approach for performing a conditional delay of block folding in a memory device at memory sub-system boot-up. A memory sub-system can be a memory device (e.g., solid-state drive [SSD]), a memory module, or a combination of a memory device and memory module. Examples of memory devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. A NAND memory device can include multiple NAND dies. Each die may include one or more planes and each plane includes multiple blocks. Each block includes an array that includes pages (rows) and strings (columns). A string includes a plurality of memory cells connected in series. A memory cell (also referred to herein simply as a “cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages (Vt) of the cells in each page according to the value that the cells are intended to represent. As the programming sequence progresses, the voltage level of the programming pulses increase until a target voltage level for each cell is reached.

The Vt distribution of a memory cell can be divided into a number of regions based on the number of bits stored by the cell where each region corresponds to a value that can be represented by the cell. More specifically, each region corresponds to a read level and each read level decodes into a multi-bit value. For example, a TLC NAND flash cell can be at one of eight charge levels (L0, L1, L2, L3, L4, L5, L6, or L7) and each charge level decodes into a 3-bit value that is stored in the flash cell (e.g., 111, 110, 100, 000, 010, 011, 001, and 101).

For memory devices such as a NAND-based memory device, Slow Charge Loss (SCL) of memory cells is a major degradation mechanism for data retention (DR). In particular, due to the effects of SCL, memory cells have their Vt distributions lose charge, with the highest Vt distributions typically losing charge faster than lower Vt distributions. SCL is usually a function of time and temperature, and can also be susceptible to other factors, such as cycling degradation (e.g., more Vt distribution shift for End of Life (EOL) blocks than for Beginning of Life (BOL) blocks). SCL usually causes a memory cell's Vt distribution to shift lower (e.g., causes the Vt distribution valley to shift lower) right after the memory cell is programmed.

Generally, to read data from a memory cell, one or more read level voltages are applied to the gate of a transistor (of the memory cell) to determine (e.g., sense) the value of the current threshold voltage (e.g., the voltage at which the transistor conducts current), and the current threshold voltage value can be decoded (e.g., mapped) to a data value (e.g., bit string) stored by the memory cell. To compensate for SCL-based shift when performing a read operation on a memory cell, an offset (or read level voltage offset) is usually applied to one or more read level voltages (also referred to herein as read levels) used to read data from the memory cell. Traditionally, the read level voltage offset applied to a memory cell is determined based on SCL tracking. Tracking SCL of memory cells is crucial to avoiding excessive latency impact, which can be caused by unnecessary error handling that results from incorrect read level placement (which can occur if a read level voltage offset applied to a read level voltage causes it to be placed without considering SCL effect on Vt distributions). Intrinsically, the effects of SCL on a memory cell hold strong dependence on a wordline (WL) group of the memory cell due to process variation (process variation that existed when the memory cell was manufactured) and asymmetric bitline (BL) cross-section at each WL. For instance, the cross-section can be larger at the top of the WL of each deck and yield smaller effective field, or the cross-section can be smaller at the bottom of the WL of each deck and yield stronger effective field. Accordingly, traditional methods for SCL tracking include performing periodic, proactive scans of blocks (comprising memory cells) and classify measured read level voltage offsets of scanned blocks into one of multiple predefined bins. Blocks with similar SCL characteristics can be grouped together in a bin to improve the management efficiency.

As an example, a block family error avoidance (BFEA) algorithm (one example of SCL tracking) can scan blocks to determine a shift of read level 7 (LVL7 or L7). The determined shift of read level 7 can be categorized into a specific bin (e.g., BFEA bin), read level voltage offsets for read levels 1 through 7 can be determined from a look-up table (LUT) (e.g., BFEA LUT) based on the specific bin (e.g., from a column of the LUT corresponding to the specific bin), and the determined read level voltage offsets can be used in a read operation (e.g., host reads) for one or more of those blocks. For example, if the shift of read level 7 of a memory cell is −23 characterized by BFEA scan, the BFEA algorithm can determine (e.g., identify) a bin (e.g., BFEA bin) that is associated with the shift of −23 (e.g., bin 5 based on example Table 1, provided below), can determine read level voltage offsets for read levels 1 through 7 from the LUT (e.g., read level voltage offsets of bin 5's column of example Table 2, provided below) based on the determined bin (e.g., column associated with the bin), and can use the one or more determined read level voltage offsets in connection with a read operation for the memory cell.

TABLE 1

| BIN | 1 | 2 | 3 | 4 | 5 | 6 | 7 |
|---|---|---|---|---|---|---|---|
| Shift | [−3, −8] | [−9, −13] | [−14, −16] | [−17, −21] | [−22, −26] | [−27, −32] | [−33, −>] |
| range | | | | | | | |

TABLE 2

| BIN | 1 | 2 | 3 | 4 | 5 | 6 | 7 |
|---|---|---|---|---|---|---|---|
| LVL1 | | | | | | | |
| LVL2 | −1 | −2 | −2 | −3 | −4 | −4 | −5 |
| LVL3 | −2 | −4 | −4 | −6 | −8 | −8 | −9 |
| LVL4 | −2 | −4 | −6 | −6 | −8 | −11 | −13 |
| LVL5 | −3 | −6 | −7 | −9 | −12 | −14 | −17 |
| LVL6 | −4 | −8 | −10 | −12 | −16 | −20 | −23 |
| LVL7 | −6 | −12 | −15 | −18 | −24 | −30 | −36 |

As the demand for longer data retention periods in NAND memory device products grows, manufacturers face challenges in maintaining optimal performance while ensuring data integrity over extended periods at elevated temperatures (e.g., 43° C.). A common issue that impacts NAND memory devices is read disturbance, a phenomenon where repeated read operations on a specific memory cell can impact the data stored in neighboring cells.

A common approach to mitigate read disturbance is read disturb handling. This method involves periodically scanning word lines of a memory device to detect potential read-disturb effects. Typically, read disturb handling algorithms perform Raw Bit Error Rate (RBER) scans on selected word lines after a predetermined number of read operations. If the RBER exceeds a predefined threshold, the affected data block is “folded” to maintain data integrity. The process of folding a block generally includes copying valid data stored by the block to another block in the memory device.

While read disturb handling effectively addresses read disturbance issues, it can present challenges in certain scenarios, particularly during system boot-up. As NAND memory devices age and experience longer retention periods, the likelihood of encountering blocks with high RBER increases. This situation may require more complex read recovery processes and additional RBER scans, potentially leading to extended boot-up times that exceed operating system requirements.

Current read disturb handling implementations typically trigger immediate block folding at boot-up when the RBER threshold is exceeded. However, this approach can conflict with strict boot-up time requirements imposed by operating systems and hardware manufacturers. For instance, some systems may require boot-up times to be under 110 seconds, which can be challenging to achieve if multiple blocks require folding during the boot process.

The conflict between maintaining data integrity through immediate block folding and meeting stringent boot-up time requirements presents a significant challenge for NAND memory device manufacturers. Balancing these competing demands is important for ensuring both the long-term reliability and the user experience of NAND memory device-equipped devices

Aspects of the present disclosure address the above and other issues by performing a conditional delay of block folding at memory sub-system boot-up. In an example, a block folding component of the memory sub-system determines, at system boot-up, whether a predetermined portion of blocks (e.g., 90%) of a memory device are classified in the highest BFEA bin (e.g., bin 7) based on a BFEA scan. That is, the block folding component determines whether the predetermined portion of the blocks are classified in the BFEA bin representing the worst condition for retention, which, in the example of Table 2, is bin 7. If so, the block folding component delays block folding until a read size of the host system satisfies a configurable read size threshold condition (e.g., the host read size exceeds a read size threshold). While delaying block folding, the block folding component adds blocks that fail an RBER check (e.g., blocks with an RBER that exceed an RBER threshold) to a block folding queue. Upon determining that the host read size satisfies the read size threshold condition, the block folding component performs block folding on the blocks in the block folding queue. If, at boot-up, the block folding component determines that less than the predetermined portion of the blocks of the memory device (e.g., less than 90%) are classified in the highest BFEA bin, the block folding component performs block folding as usual without delay.

This delayed folding approach offers advantages in balancing boot-up performance and long-term data reliability, among others. By implementing a configurable host read threshold, this approach allows the memory device to complete boot-up processes before initiating potentially time-consuming folding operations. This results in faster boot-up times, meeting stringent operating system requirements while still maintaining data integrity through the eventual folding of blocks that fail RBER checks. Furthermore, this approach addresses the challenges posed by longer data retention periods and higher operating temperatures, which are increasingly common in modern NAND memory device applications.

In addition, the flexibility of this approach extends beyond boot-up scenarios, potentially improving overall read performance in high data retention situations. By queuing blocks that require folding based on RBER checks and initiating folding operations only after a cumulative read size threshold is met, the system can dynamically balance immediate performance needs with long-term reliability concerns. This approach allows NAND memory device manufacturers to better meet the evolving demands of both operating system requirements and end-user expectations for quick system responsiveness, while still ensuring the longevity and reliability of data storage over extended periods.

FIG. 1 illustrates an example computing environment 100 that includes a memory sub-system 110, in accordance with some embodiments of the present disclosure.

The memory sub-system 110 can include media, such as one or more volatile memory devices (e.g., memory device 140), one or more non-volatile memory devices (e.g., memory device 130), or a combination of such.

A memory sub-system 110 can be a memory device, a memory module, or a hybrid of a memory device and memory module. Examples of a memory device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as single level cells (SLCs), multi-level cells (MLCs) (e.g., triple level cells (TLCs), or quad-level cells (QLCs)). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 115 can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a block folding component 113 that is responsible for folding blocks in the memory device 130. As an example, at system boot-up (also referenced as “power-up” herein), the block folding component 113 determines whether a predetermined portion of blocks in the memory device 130 are classified in the highest BFEA bin. If this condition is met, the block folding component 113 implements a delayed folding mode, postponing block folding until the read size of the host system 120 (cumulative amount of data read by the host system 120) satisfies a configurable read size threshold condition. During this delayed mode, instead of immediately folding blocks that fail an RBER check, the block folding component 113 adds them to a block folding queue. The block folding component 113 continuously monitors the host read size, and once the threshold is met, the block folding component 113 initiates folding operations for the queued blocks. However, if less than the predetermined portion of blocks are in the highest BFEA bin at boot-up, the block folding component 113 performs block folding without delay, following normal operations. This adaptive approach enables the block folding component 113 to balance data integrity needs with boot-up performance requirements, particularly in scenarios involving extended data retention periods and elevated operating temperatures.

In some embodiments, the memory sub-system controller 115 includes at least a portion of the block folding component 113. For example, the memory sub-system controller 115 can include a processor 117 (processing device) configured to execute instructions stored in local memory 119 (e.g., firmware) for performing the operations described herein. In some embodiments, the block folding component 113 is part of the host system 120, an application, or an operating system. Further details regarding the block folding component 113 are discussed below.

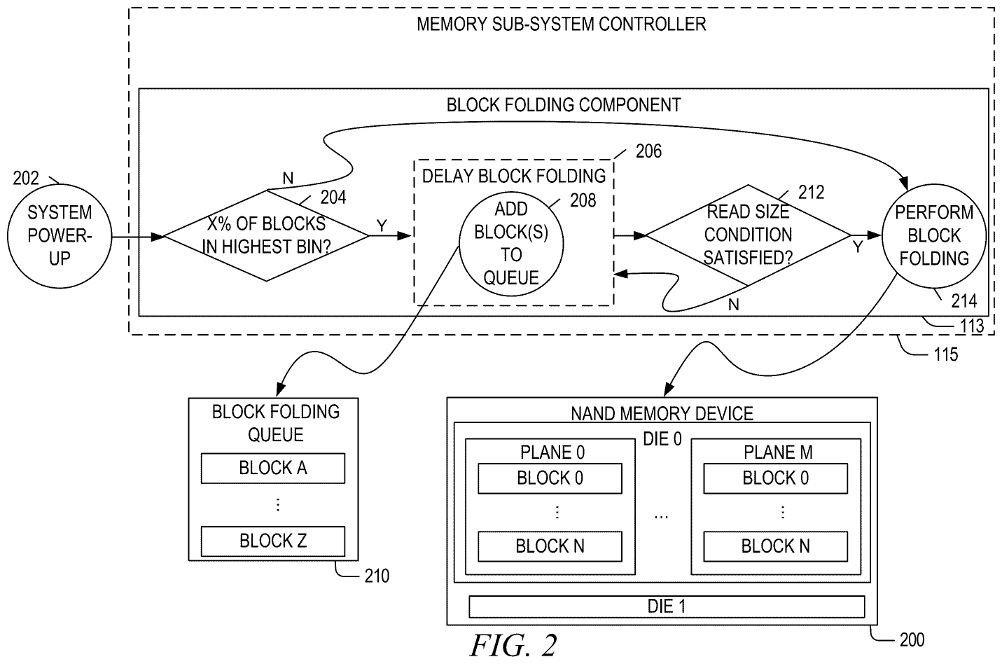

FIG. 2 is data flow diagrams illustrating interactions between components in the memory sub-system in performing a conditional delay of block folding in a memory device 200 at boot-up, in accordance with some examples. In the example illustrated in FIG. 2, the memory device 200 is an example memory device 130 in the example form of a NAND memory device.

The memory device 200 includes multiple NAND dies. Each die may include one or more planes and each plane includes multiple blocks such as block₀-block₈ illustrated in FIG. 2. Each block includes a two or three dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide insulating layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory includes an SLC portion that includes multiple SLCs and a QLC portion that includes multiple QLCs.

As noted above, each NAND cell stores data in the form of the threshold voltage (VT) of the transistor. The range of threshold voltages of a memory cell can be divided into a number of regions based on the number of bits stored by the cell where each region corresponds to a value that can be represented by the cell. More specifically, each region corresponds to a read voltage level (also referred to simply as “read level”) and each read voltage level decodes into a multi-bit value. For example, a TLC NAND flash cell can be at one of eight read levels (L0, L1, L2, L3, L4, L5, L6, or L7) and each read level decodes into a 3-bit value that is stored in the flash cell (e.g., 111, 110, 100, 000, 010, 011, 001, and 101).

Each block of the memory device 200 is classified into a bin from among multiple predefined bins based on read level shifts of the blocks (e.g., a shift of read level 7). Each bin has a corresponding read level voltage offset to apply to blocks in the bin. The bin classifications for each block of the memory device 200 are determined based on a BFEA scan, which in some examples, may be performed prior to power down of the memory sub-system 110. During the BFEA scan, the blocks are scanned to determine the shift of read level 7 (LVL7 or L7) and the determined shift of read level 7 of each block is categorized into a specific bin (e.g., BFEA bin) among the multiple predefined bins.

As shown, at power-up 202 of the memory sub-system 110, the block folding component 113 determines, based on one or more BFEA scans, whether at least a predetermined portion (e.g., 90%; referenced as “X %” in FIG. 2) of the blocks of the memory device 200 are classified in the highest BFEA bin (operation 204). The highest bin refers to the bin in the BFEA classification system that represents the most severe read level shifts for memory blocks. This bin is associated with the largest negative shift in read level 7 (LVL7 or L7) and corresponds to the worst condition for data retention, typically indicating blocks that require the most significant read level voltage offsets to compensate for SCL effects

If the block folding component 113 determines that less than the predetermined portion of the blocks of the memory device 200 are in the highest BFEA bin, the block folding component 113 performs block folding without delay. In performing block folding, the block folding component 113 folds blocks with an RBER that satisfies an RBER threshold condition (e.g., when the RBER of a block exceeds an RBER threshold corresponding to the RBER threshold condition). In folding a block, the block folding component 113 copies valid data from the block to another block.

If the block folding component 113 determines that at least the predetermined portion of the blocks of the memory device 200 are classified in the highest BFEA bin, the block folding component 113 delays block folding (operation 206) until a read size of the host system 120 satisfies a host read size threshold condition. The host read size refers to a cumulative amount of data read from the memory device 200 by the host system upon system boot-up. In an example, the host read size threshold condition comprises a read size threshold. The read size threshold is a configurable parameter can be set based on various factors such as the size of the operating system (OS) image, the size of host read operations during boot-up, and/or a predefined data size that ensures system boot-up is complete. By delaying block folding until after a certain amount of data has been read by the host, the block folding component 113 enables the system to achieve faster boot-up times while still maintaining data integrity through the eventual folding of blocks

While block folding is delayed, the block folding component 113, at operation 208, adds blocks to a block folding queue 210 that fail an RBER check. That is, the block folding component 113 adds blocks to the block folding queue 210 that have an RBER that satisfies an RBER threshold condition (e.g., an RBER that exceeds an RBER threshold).

Based on determining the read size of the host system 120 satisfies the read size threshold condition at operation 212, the block folding component 113 performs block folding, at operation 214, of the one or more blocks in the block folding queue 210.

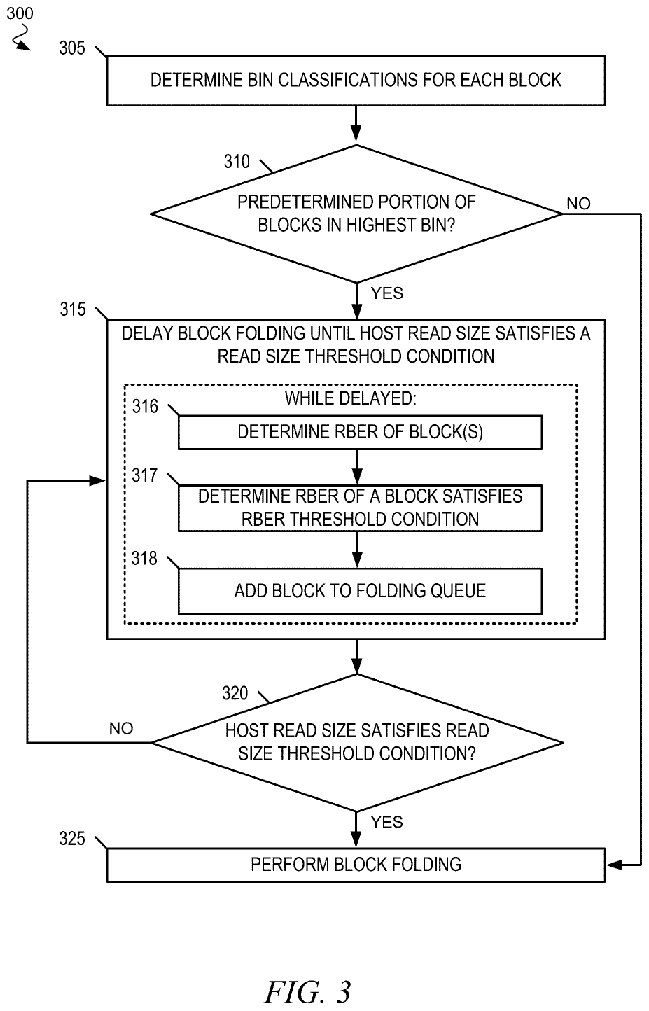

FIG. 3 is a flow diagram illustrating an example method 300 for performing a conditional delay of block folding in a memory device at memory sub-system boot-up, in accordance with some examples. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the block folding component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

To set the context of method 300, the memory device includes a set of blocks and the method 300 is initiated at power up of the memory sub-system.

At operation 305, the processing device determines bin classifications for each block in the set of blocks of the memory device. As noted above, each block in the set of blocks is classified into a bin from among multiple predefined bins based on read level shifts of the set of blocks (e.g., a shift of read level 7). The bins classifications for each block in the set of blocks are determined based on a BFEA scan, which in some examples, may be performed prior to power down of the memory sub-system.

At operation 310, the processing device determines whether a at least a predetermined portion of the set of blocks (e.g., 90%) are classified as being in the highest bin (e.g., Bin 7) of the multiple bins. Based on determining the predetermined portion of the set of blocks are classified as being in the highest bin, the processing device, at operation 315, delays block folding until a host (e.g., host system 120) read size satisfies a read size threshold condition.

While block folding is being delayed, the processing device adds one or more blocks to a folding queue. For example, as shown, while delaying block folding, the processing device determines a RBER of one or more blocks in the set of blocks, at operation 316. Based on determining the RBER of a block satisfying an RBER threshold condition (operation 317), the processing device adds the block to the block folding queue (operation 318). That is, each block that has an RBER that satisfies the RBER threshold condition is added to the folding queue. In an example, the RBER threshold condition comprises an RBER threshold and determining that the RBER of a block satisfies the RBER threshold condition comprises determining the RBER of the block exceeds the RBER threshold.

At operation 320, the processing device determines whether the host read size satisfies the host read size threshold condition. In an example, the host read size condition comprises a host read size threshold, and determining whether the host read size satisfies the host read size threshold condition comprises determining the host read size exceeds the host read size threshold. In an example, the host read size is based on an operating system image size of the computing system in which the memory sub-system resides. In another example, the host read size is based on the size of host read operations during boot-up.

If at operation 320, the processing device determines that the host read size does not satisfy the read size threshold condition, the processing device continues to delay block folding.

If, at operation 310, the processing device determines that less than the predefined portion of the set of blocks (e.g., less than 90%) are classified in the highest bin or if, at operation 320, the processing device determines that the host read size does satisfy the read size threshold condition, the method proceeds to operation 325, where the processing device performs folding of one or more blocks. Folding a block comprises copying valid data stored by the block to another block. In instances in which the processing device delays block folding, the processing device folds blocks added to the folding queue during the delay. In other instances, the processing device folds blocks with a RBER that satisfies the RBER threshold condition.

Described implementations of the subject matter can include one or more features, alone or in combination as illustrated below by way of example.

Example 1. A memory sub-system comprising: a memory device comprising a set of blocks; and a processing device, operatively coupled with the memory device, to perform operations comprising: determining, at power-up of the memory sub-system, a bin classification of each block in the set of blocks based on one or more block family error avoidance (BFEA) scans, the bin classification of a block of the set of blocks corresponding to a bin determined from multiple bins; determining, based on the bin classification of each block, that a predetermined portion of the set of blocks are classified as being in a highest bin of the multiple bins, the highest bin being associated with a most severe read level shift among the multiple bins; based on determining the predetermined portion of the set of blocks are classified as being in the highest bin, delaying block folding until a host read size satisfies a read size threshold condition; determining the host read size satisfies the read size threshold condition; and based on determining the host read size satisfies the threshold condition, folding one or more blocks from the set of blocks.

Example 2. The subject matter of Example 1, wherein the operations comprise adding the one or more blocks from the set of blocks to a folding queue while delaying the block folding, wherein the folding of the one or more blocks is based on the one or more blocks being added to the folding queue.

Example 3. The subject matter of Examples 1-2, wherein the operations comprise determining a bit error rate for the one or more blocks based on a bit error rate scan, wherein the adding of the one or more blocks to the folding queue is based on the bit error rate for the one or more blocks.

Example 4. The subject matter of Examples 1-3, wherein the operations comprise determining the bit error rate for the one or more blocks satisfies a bit error rate threshold condition, wherein the adding of the one or more blocks to the folding queue is based on the bit error rate for the one or more blocks satisfying the bit error rate threshold condition.

Example 5. The subject matter of Examples 1-4, wherein the read size threshold condition comprises a read size threshold based on a size of an operating system image.

Example 6. The subject matter of Examples 1-5, wherein the read size threshold condition comprises a read size threshold based on a size of an operating system image.

Example 7. The subject matter of Examples 1-6, wherein the read size threshold condition comprises a first read size threshold, wherein the operations comprise configuring the read size threshold condition to comprise a second read size threshold.

Example 8. The subject matter of Examples 1-7, wherein: the power-up of the memory sub-system is a first power-up of the memory sub-system; the operations comprise: at a second power-up of the memory sub-system, determining less than the predetermined portion of the set of blocks are associated with the highest bin; and based determining that less than the predetermined portion of the set of blocks are associated with the highest bin, performing block folding without delay.

Example 9. The subject matter of Examples 1-8, wherein the folding of one or more blocks from the set of blocks comprises copying valid data stored by a first block to a second block.

Example 10. A method comprising: determining, at power-up of a memory sub-system comprising a memory device, a bin classification for each block in a set of blocks of the memory device based on one or more block family error avoidance (BFEA) scans, the bin classification of a block of the set of blocks corresponding to a bin determined from multiple bins; determining, by a processing device, based on the bin classification of each block, that a predetermined portion of the set of blocks are classified as being in a highest bin of the multiple bins, the highest bin being associated with a most severe read level shift among the multiple bins; based on determining the predetermined portion of the set of blocks are classified as being in the highest bin, delaying, by the processing device, block folding until a host read size satisfies a read size threshold condition; determining the host read size satisfies the read size threshold condition; and based on determining the host read size satisfies the threshold condition, performing block folding, the performing of block folding comprising copying valid data from a first block from the set of blocks to a second block from the set of blocks.

Example 11. The subject matter of Example 10, comprising adding the first block from the set of blocks to a folding queue while delaying the block folding, wherein the copying of the valid data from the first block to the second block is based on the one or more blocks being added to the folding queue.

Example 12. The subject matter of Examples 10-11, comprising determining a bit error rate for the one or more blocks based on a bit error rate scan, wherein the adding of the one or more blocks to the folding queue is based on the bit error rate for the one or more blocks.

Example 13. The subject matter of Examples 10-12, comprising determining the bit error rate for the first block satisfies a bit error rate threshold condition, wherein the adding of the first block to the folding queue is based on the bit error rate for the first block satisfying the bit error rate threshold condition.

Example 14. The subject matter of Examples 10-13, wherein the read size threshold condition comprises a read size threshold based on a size of an operating system image.

Example 15. The subject matter of Examples 10-14, wherein the read size threshold condition comprises a read size threshold based on a size of an operating system image.

Example 16. The subject matter of Examples 10-15, wherein the read size threshold condition comprises a first read size threshold, wherein the method comprises configuring the read size threshold condition to comprise a second read size threshold.

Example 17. The subject matter of Examples 10-16, wherein, the power-up of the memory sub-system is a first power-up of the memory sub-system, the method comprising: at a second power-up of the memory sub-system, determining less than the predetermined portion of the set of blocks are associated with the highest bin; and based determining that less than the predetermined portion of the set of blocks are associated with the highest bin, performing block folding without delay.

Example 18. A computer-readable storage medium comprising instructions that, when executed by a processing device, configure the processing device to perform operations comprising: determining, at power-up of a memory sub-system comprising a memory device, a bin classification for each block in a set of blocks of the memory device based on one or more block family error avoidance (BFEA) scans, the bin classification of a block of the set of blocks corresponding to a bin determined from multiple bins; determining, based on the bin classification of each block, that a predetermined portion of the set of blocks are classified as being in a highest bin of the multiple bins, the highest bin being associated with a most severe read level shift among the multiple bins; based on determining the predetermined portion of the set of blocks are classified as being in the highest bin, delaying, by the processing device, block folding until a host read size satisfies a read size threshold condition; adding a block from the set of blocks to a folding queue while delaying the block folding; determining the host read size satisfies the read size threshold condition; and in response to determining the host read size satisfies the threshold condition, folding one or more blocks in the folding queue, the folding of the one or more blocks comprising folding the block based on the block being added to the folding queue.

Example 19. The subject matter of Example 18, wherein the operations comprise determining a bit error rate for the one or more blocks based on a bit error rate scan, wherein the adding of the one or more blocks to the folding queue is based on the bit error rate for the one or more blocks.

Example 20. The subject matter of Examples 18-19, wherein the operations comprise determining the bit error rate for the one or more blocks satisfies a bit error rate threshold condition, wherein the adding of the one or more blocks to the folding queue is based on the bit error rate for the one or more blocks satisfying the bit error rate threshold condition.

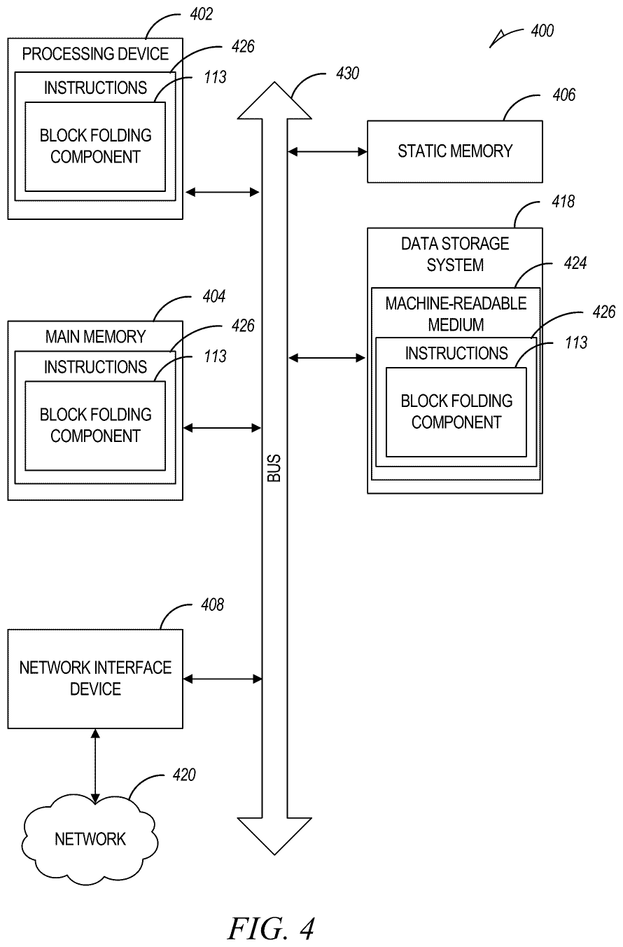

FIG. 4 illustrates an example machine in the form of a computer system within which a set of instructions can be executed for causing the machine to perform any one or more of the methodologies discussed herein. FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the block folding component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., ROM, flash memory, DRAM such as SDRAM or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an ASIC, a FPGA, a digital signal processor (DSP), network processor, or the like. The processing device 402 is configured to execute instructions 426 for performing the operations and steps discussed herein. The computer system 400 can further include a network interface device 408 to communicate over a network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a security component (e.g., the block folding component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device comprising a set of blocks; and
a processing device, operatively coupled with the memory device, to perform operations comprising:
determining, at power-up of the memory sub-system, a bin classification of each block in the set of blocks based on one or more block family error avoidance (BFEA) scans, the bin classification of a block of the set of blocks corresponding to a bin determined from multiple bins;
determining, based on the bin classification of each block, that a predetermined portion of the set of blocks are classified as being in a highest bin of the multiple bins, the highest bin being associated with a most severe read level shift among the multiple bins;
based on determining the predetermined portion of the set of blocks are classified as being in the highest bin, delaying block folding until a host read size satisfies a read size threshold condition;
determining the host read size satisfies the read size threshold condition; and
based on determining the host read size satisfies the threshold condition, folding one or more blocks from the set of blocks.

2. The memory sub-system of claim 1, wherein the operations comprise adding the one or more blocks from the set of blocks to a folding queue while delaying the block folding, wherein the folding of the one or more blocks is based on the one or more blocks being added to the folding queue.

3. The memory sub-system of claim 2, wherein the operations comprise determining a bit error rate for the one or more blocks based on a bit error rate scan, wherein the adding of the one or more blocks to the folding queue is based on the bit error rate for the one or more blocks.

4. The memory sub-system of claim 3, wherein the operations comprise determining the bit error rate for the one or more blocks satisfies a bit error rate threshold condition, wherein the adding of the one or more blocks to the folding queue is based on the bit error rate for the one or more blocks satisfying the bit error rate threshold condition

5. The memory sub-system of claim 1, wherein the read size threshold condition comprises a read size threshold based on a size of an operating system image.

6. The memory sub-system of claim 1, wherein the read size threshold condition comprises a read size threshold based on a size of an operating system image.

7. The memory sub-system of claim 1, wherein the read size threshold condition comprises a first read size threshold, wherein the operations comprise configuring the read size threshold condition to comprise a second read size threshold.

8. The memory sub-system of claim 1, wherein:
the power-up of the memory sub-system is a first power-up of the memory sub-system;
the operations comprise:
at a second power-up of the memory sub-system, determining less than the predetermined portion of the set of blocks are associated with the highest bin; and
based determining that less than the predetermined portion of the set of blocks are associated with the highest bin, performing block folding without delay.

9. The memory sub-system of claim 1, wherein the folding of one or more blocks from the set of blocks comprises copying valid data stored by a first block to a second block.

10. A method comprising:
determining, at power-up of a memory sub-system comprising a memory device, a bin classification for each block in a set of blocks of the memory device based on one or more block family error avoidance (BFEA) scans, the bin classification of a block of the set of blocks corresponding to a bin determined from multiple bins;
determining, by a processing device, based on the bin classification of each block, that a predetermined portion of the set of blocks are classified as being in a highest bin of the multiple bins, the highest bin being associated with a most severe read level shift among the multiple bins;
based on determining the predetermined portion of the set of blocks are classified as being in the highest bin, delaying, by the processing device, block folding until a host read size satisfies a read size threshold condition;
determining the host read size satisfies the read size threshold condition; and
based on determining the host read size satisfies the threshold condition, performing block folding, the performing of block folding comprising copying valid data from a first block from the set of blocks to a second block from the set of blocks.

11. The method of claim 10, comprising adding the first block from the set of blocks to a folding queue while delaying the block folding, wherein the copying of the valid data from the first block to the second block is based on the one or more blocks being added to the folding queue.

12. The method of claim 11, comprising determining a bit error rate for the one or more blocks based on a bit error rate scan, wherein the adding of the one or more blocks to the folding queue is based on the bit error rate for the one or more blocks.

13. The method of claim 12, comprising determining the bit error rate for the first block satisfies a bit error rate threshold condition, wherein the adding of the first block to the folding queue is based on the bit error rate for the first block satisfying the bit error rate threshold condition

14. The method of claim 10, wherein the read size threshold condition comprises a read size threshold based on a size of an operating system image.

15. The method of claim 10, wherein the read size threshold condition comprises a read size threshold based on a size of an operating system image.

16. The method of claim 10, wherein the read size threshold condition comprises a first read size threshold, wherein the method comprises configuring the read size threshold condition to comprise a second read size threshold.

17. The method of claim 11, wherein,
the power-up of the memory sub-system is a first power-up of the memory sub-system, the method comprising:
at a second power-up of the memory sub-system, determining less than the predetermined portion of the set of blocks are associated with the highest bin; and
based determining that less than the predetermined portion of the set of blocks are associated with the highest bin, performing block folding without delay.

18. A computer-readable storage medium comprising instructions that, when executed by a processing device, configure the processing device to perform operations comprising:
determining, at power-up of a memory sub-system comprising a memory device, a bin classification for each block in a set of blocks of the memory device based on one or more block family error avoidance (BFEA) scans, the bin classification of a block of the set of blocks corresponding to a bin determined from multiple bins;
determining, based on the bin classification of each block, that a predetermined portion of the set of blocks are classified as being in a highest bin of the multiple bins, the highest bin being associated with a most severe read level shift among the multiple bins;
based on determining the predetermined portion of the set of blocks are classified as being in the highest bin, delaying, by the processing device, block folding until a host read size satisfies a read size threshold condition;
adding a block from the set of blocks to a folding queue while delaying the block folding;
determining the host read size satisfies the read size threshold condition; and
in response to determining the host read size satisfies the threshold condition, folding one or more blocks in the folding queue, the folding of the one or more blocks comprising folding the block based on the block being added to the folding queue.

19. The computer-readable storage medium of claim 18, wherein the operations comprise determining a bit error rate for the one or more blocks based on a bit error rate scan, wherein the adding of the one or more blocks to the folding queue is based on the bit error rate for the one or more blocks.

20. The computer-readable storage medium of claim 19, wherein the operations comprise determining the bit error rate for the one or more blocks satisfies a bit error rate threshold condition, wherein the adding of the one or more blocks to the folding queue is based on the bit error rate for the one or more blocks satisfying the bit error rate threshold condition
